(19) United States
(12) Patent Application Publication
(10) Pub. No.: US 2017/0322825 A1
(43) Pub. Date: Nov. 9, 2017

(54) METHOD OF PROCESSING INPUT AND OUTPUT OF VIRTUAL MACHINE

(71) Applicant: ELECTRONICS AND TELECOMMUNICATIONS RESEARCH INSTITUTE, Daejeon (KR)

(72) Inventors: Song Woo SOK, Daejeon (KR); Young Woo JUNG, Daejeon (KR)

(21) Appl. No.: 15/400,895

(22) Filed: Jan. 6, 2017

(30) Foreign Application Priority Data
May 3, 2016 (KR) 10-2016-0054504

(51) Int. Cl. G06F 9/455

(52) U.S. Cl. CPC G06F 9/45558; G06F 2009/45579

(57) ABSTRACT

Provided is a method of processing an input and output of a virtual machine. The method includes transferring, by a frontend virtual driver of a first virtual machine, an input and output command to a hypervisor, storing, by hypervisor, a context of the first virtual machine in response to the input and output command, executing, by the hypervisor, an interface of each of a physical driver and a backend virtual driver, installed in a second virtual machine independent from the first virtual machine, in the first virtual machine, and transferring, by the first virtual machine, the input and output command to an input/output device through the interface of each of the physical driver and the backend virtual driver.

### CROSS-REFERENCE TO RELATED APPLICATIONS

This application claims priority under 35 U.S.C. §119 to Korean Patent Application No. 10-2016-0054504, filed on MAY 3, 2016, the disclosure of which is incorporated herein by reference in its entirety.

### TECHNICAL FIELD

The present invention relates to a method of processing an input and output of a virtual machine, and more particularly, to a method for improving the input and output performance of a virtual machine in a server where a plurality of virtual machines are executed.

### BACKGROUND

Virtual machines denote that an independent machine is generated in a virtual environment by using hardware and software resources such as a conventional server and/or the like. In detail, a plurality of virtual machines are generated by using one or more servers and each operate as an independent operating system (OS).

In a case of using virtual machines, since the virtual machines share a processor and a memory, the processor and the memory shared by the virtual machines are managed by using technology such as hypervisor.

Generally, a processor resource is temporally divided, and scheduling is performed in order for only one virtual machine to be used at a corresponding time. Also, a memory is divided into a plurality of areas, and the plurality of areas are respectively allocated to virtual machines so as not to intersect each other.

Frequently, an input/output device is physically fixed to one device, and only one agent is accessible thereto. For this reason, a hypervisor or an OS of the main virtual machine (DomO) exclusively manages the input/output device, and instead of the DomO virtual machine, a conventional virtual machine (DomU) executes an input and output by using a virtual input/output device. Also, the DomO virtual machine or the hypervisor recognizes the input and output to execute an actual input and output.

In order to execute an input and output in such a method, the DomO virtual machine should be necessarily executed. Therefore, the DomO virtual machine should be executed through a scheduling operation of selecting and executing an appropriate virtual machine, based on time.

However, in a case of desiring to execute the DomO virtual machine for processing an input and output in the above-described method, switching occurs between virtual machines, and a switching duration is very short. However, when the switching occurs frequently, a central processing unit (CPU) time incapable of being ignored is consumed, and a duration where the virtual machines occupy a processor is shortened, causing the degradation in performance of the virtual machines.

In conventional virtualization technology such as Xen, switching between the DomO virtual machine and the DomU virtual machine is performed at a relatively long period of several tens ms, and for this reason, input and output performance is considerably degraded.

In order to solve such a problem, vSlicer technology uses a method that shortens a scheduling period of a virtual machine processing an input and output, but by increasing a frequency number of scheduling, reduces an input/output response time.

The vSlicer technology enhances input and output performance, but still maintains a long scheduling period of virtual machines other than a virtual machine processing an input and output. For this reason, performance is limited.

### SUMMARY

Accordingly, the present invention provides a method which reduces switching to a DomO virtual machine in an input/output processing operation and thus solves a problem where due to an increase in switching and communication between virtual machines, a processing load increases, and a switching time is delayed.

The object of the present invention is not limited to the aforesaid, but other objects not described herein will be clearly understood by those skilled in the art from descriptions below.

In one general aspect, a method of processing an input and output of a virtual machine includes: transferring, by a frontend virtual driver of a first virtual machine, an input and output command to a hypervisor; storing, by hypervisor, a context of the first virtual machine in response to the input and output command; excuting, by the hypervisor, an interface of each of a physical driver and a backend virtual driver, installed in a second virtual machine independent from the first virtual machine, in the first virtual machine; and transferring, by the first virtual machine, the input and output command to an input/output device through the interface of each of the physical driver and the backend virtual driver.

In another general aspect, a method of processing an input and output of a virtual machine includes: transferring, by a frontend virtual driver of a first virtual machine, an input and output command to a hypervisor; storing, by hypervisor, a context of the first virtual machine in response to the input and output command; executing, by the hypervisor, an interface of a backend virtual driver, installed in a second virtual machine independent from the first virtual machine, in the first virtual machine; transferring the input and output command to a physical driver of the second virtual machine through a backend virtual driver of the first virtual machine; and transferring, by the second virtual machine, the input and output command to an input/output device through the physical driver installed in the second virtual machine.

Other features and aspects will be apparent from the following detailed description, the drawings, and the claims.

### BRIEF DESCRIPTION OF THE DRAWINGS

FIG. 1 is a structure diagram illustrating a related art method of processing an input and output of virtual machine.

FIG. 2 is a structure diagram of a system executing an input/output method of a virtual machine according to an embodiment of the present invention.

FIG. 3 is a flowchart of an input/output method of a virtual machine according to an embodiment of the present invention.

FIG. 4 is a structure diagram of a system executing an input/output method of a virtual machine according to another embodiment of the present invention.

FIG. 5 is a flowchart of an input/output method of a virtual machine according to another embodiment of the present invention.

FIG. 6 is a structure diagram of a computer system executing an input/output method of a virtual machine according to an embodiment of the present invention.

### DETAILED DESCRIPTION OF EMBODIMENTS

The advantages, features and aspects of the present invention will become apparent from the following description of the embodiments with reference to the accompanying drawings, which is set forth hereinafter. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

The terms used herein are for the purpose of describing particular embodiments only and are not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Hereinafter, embodiments of the present invention will be described in detail with reference to the accompanying drawings.

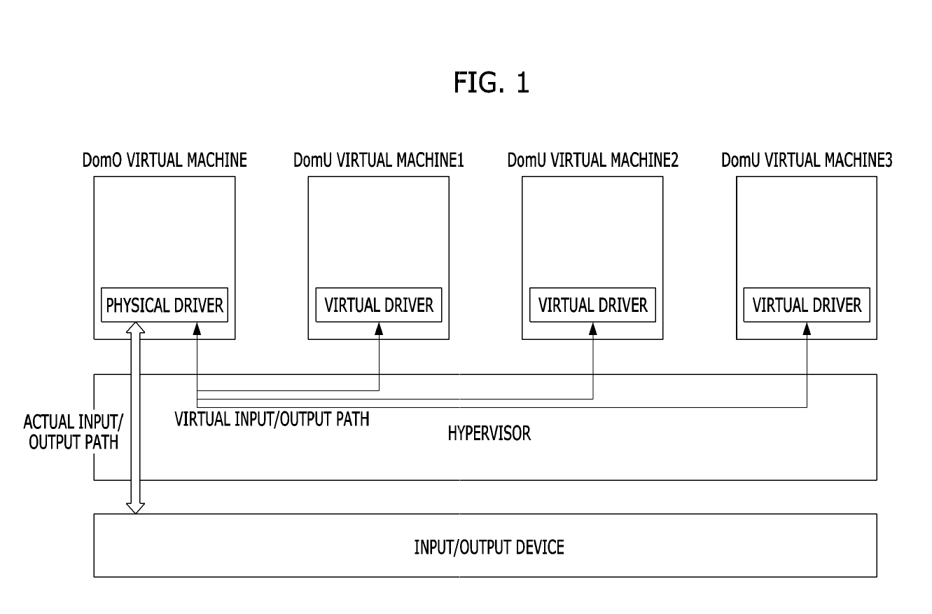

FIG. 1 is a structure diagram illustrating a method of processing an input and output in an environment where a conventional virtual machine is used.

Since a physical driver for processing an input and output is installed in a DomO virtual machine, DomU virtual machines process an input and output by using the physical driver of the DomO virtual machine.

The DomU virtual machine may perform the following process for processing an input and output.

First, the DomU virtual machine may transfer an input/output command, which is to be processed by using an input/output device, to the DomO virtual machine. In an operation where the DomU virtual machine transfers the input/output command, the DomU virtual machine may use a virtual driver instead of a physical driver, and the input/output command may be transferred to the DomO virtual machine through a virtual input/output path.

The DomO virtual machine which has received the input/output command may access a hardware input/output device through an actual input/output path using the physical driver and may execute the command transferred from the DomU virtual machine.

The DomO virtual machine may execute the input/output command, and then, when a result of the execution is received from the input/output device and is transferred to the DomU virtual machine, the DomU virtual machine may recognize that the input/output command has been executed.

Therefore, in order to execute an input and output according to such a processing sequence, the DomO virtual machine and the DomU virtual machine may be alternately executed with time, and an operation may be processed.

When switching between virtual machines is frequently performed, a duration where a processor shared by the virtual machines is occupied is shortened, and for this reason, whole system performance is degraded.

Therefore, a method of processing an input and output of a virtual machine according to an embodiment of the present invention minimizes intervention of the DomO virtual machine in input/output processing, thereby shortening an input/output delay time.

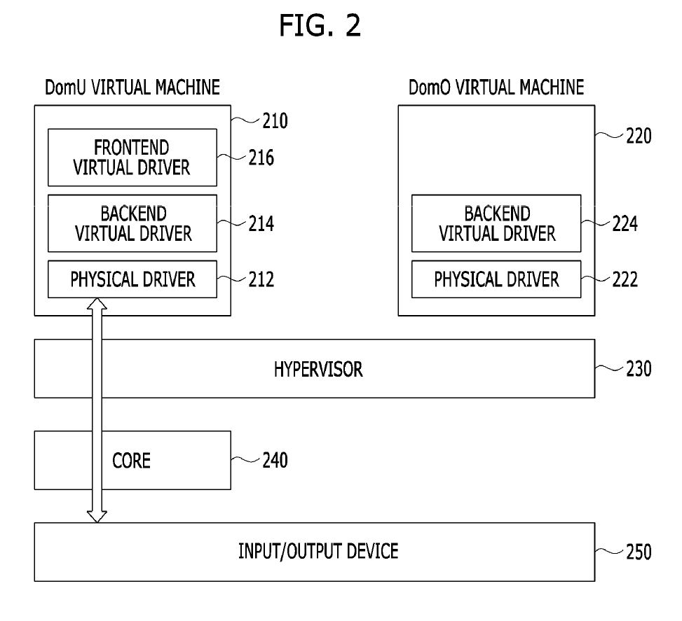

FIG. 2 illustrates a structure where a method of processing an input and output of a virtual machine according to an embodiment of the present invention is executed in a single core system.

Generally, in an operation of accessing a physical device such as an input/output device in a virtual machine environment, a backend virtual driver 224 and a physical driver 222 may be executed in only a DomO virtual machine 220 that is a host virtual machine, for ensuring integrity and exclusiveness of access.

In an embodiment of the present invention, in order to reduce a frequency number of switching to the DomO virtual machine 220, a structure of the backend virtual driver 222 of the DomO virtual machine 220 may be changed to a structure where re-entry is ensured, and by providing an interface to a hypervisor 230, in addition to a frontend virtual driver 216, a physical driver 212 and a backend virtual driver 214 may also be executed in a DomU virtual machine 210.

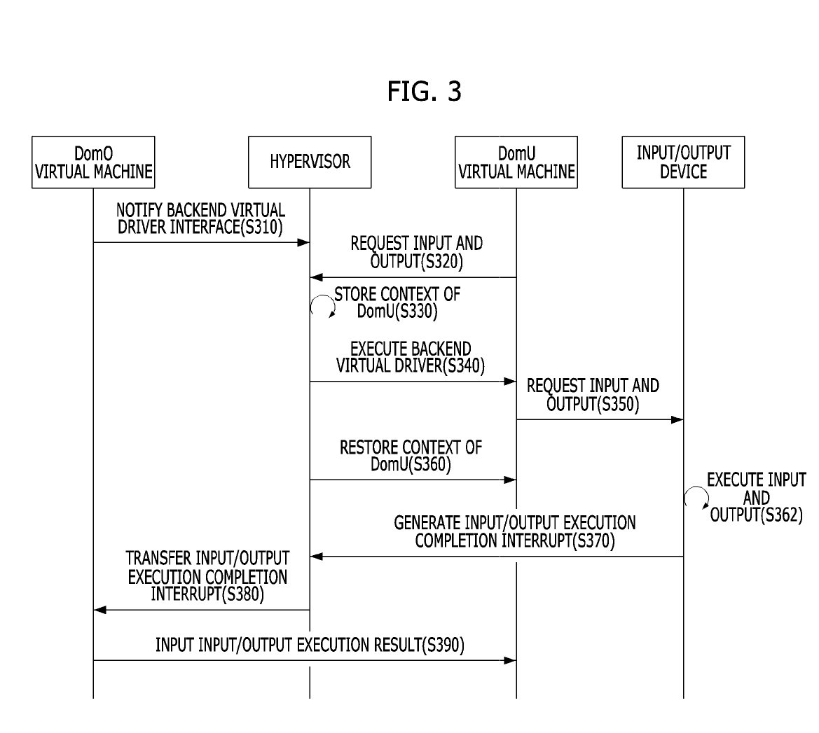

FIG. 3 is a flowchart of a method, executed in a single core system, of processing an input and output of a virtual machine according to an embodiment of the present invention.

When a DomO virtual machine is executed, the DomO virtual machine may notify a hypervisor of an interface of a backend virtual driver in step S310. The interface of the backend virtual driver may include a start address of a corresponding function, a kind of a parameter, etc., and thus, a virtual machine may call and use the backend virtual driver.

When a DomU virtual machine requests an input and output through a frontend virtual driver in step S320, the hypervisor may trap the request and may store a context of the DomU virtual machine in step S330.

The context denotes data for restoring a status of the virtual machine, and in detail, denotes data such as a register value for returning to a status before occurrence of an interrupt after a processor stops an executed operation due to the occurrence of the interrupt and executes an interrupt command.

The hypervisor may execute a backend virtual driver in the DomU virtual machine in step S340, and an input/output command may be transferred to an input/output device through a physical driver in step S350.

When the input/output command is transferred to an input/output device, the hypervisor may restore the context of the DomU virtual machine in step S360, and the input/output device may execute an input and output according to the received input/output command in step S362.

The DomU virtual machine has returned to its own context after the input/output command is executed, and thus, when the input/output device generates an input/output execution completion interrupt in step S370, the hypervisor may transfer the interrupt to a physical driver of the DomO virtual machine in step S380.

The DomO virtual machine may receive the interrupt and may transfer the received interrupt to the DomU virtual machine in step S390, and when a scheduling time elapses, the DomU virtual machine may receive a result of the scheduling.

According to the above-described method, since the DomU virtual machine can directly call and process a backend virtual driver and a physical driver of the DomO virtual machine, the DomU virtual machine may directly transfer the input/output command to the input/output device without switching to the DomO virtual machine.

Moreover, in a single core system, while the DomU virtual machine is accessing the input/output device, the DomO virtual machine or other DomU virtual machines cannot access the processor or a physical device, thereby maintaining integrity.

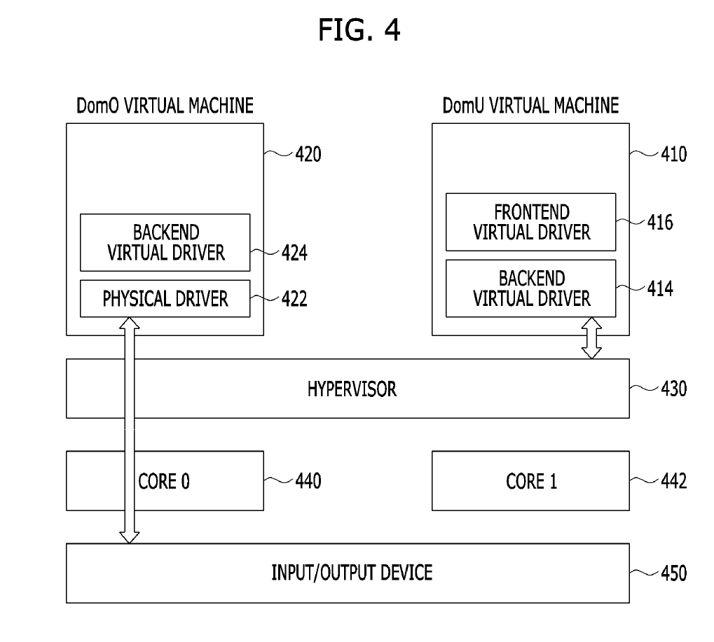

FIG. 4 illustrates a structure where a method of processing an input and output of a virtual machine according to another embodiment of the present invention is executed in a multi-core system including two or more processors.

Unlike the single core system, a DomU virtual machine 410 may be executed in a core 1 442, and a DomO virtual machine 420 may be executed in a core 0 440.

Likewise with the single core system, the DomU virtual machine 410 may directly call and execute a backend virtual driver 424 and a physical driver 422.

Moreover, the DomU virtual machine 410 may include a backend virtual driver 414 and a frontend virtual driver 416.

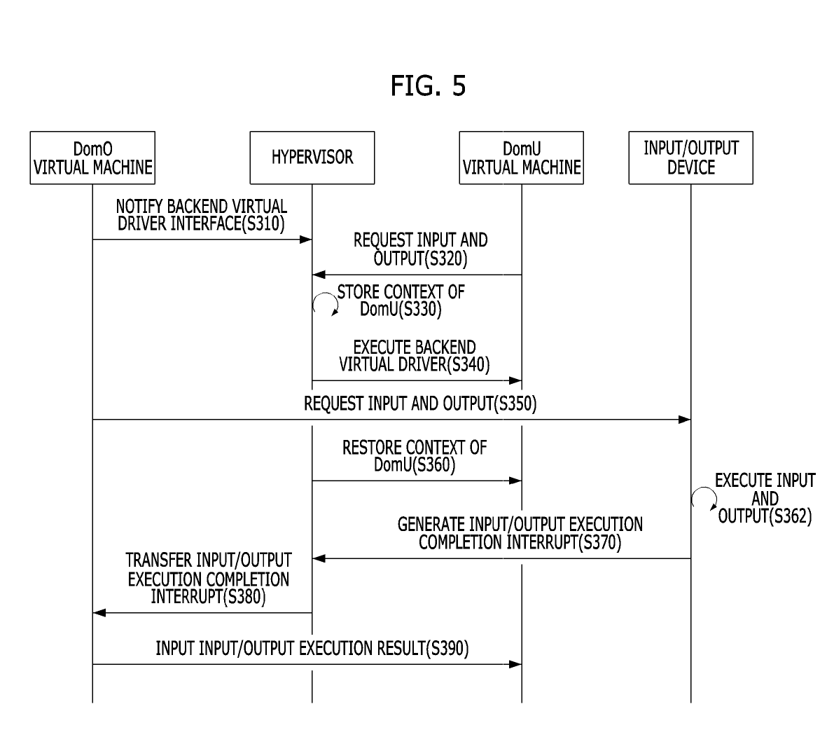

FIG. 5 is a flowchart of a method, executed in a multi-core system, of processing an input and output of a virtual machine according to an embodiment of the present invention.

When a DomO virtual machine is executed, the DomO virtual machine may notify a hypervisor of an interface of a backend virtual driver in step S510. The interface of the backend virtual driver may include a start address of a corresponding function, a kind of a parameter, etc., and thus, a virtual machine may call and use the backend virtual driver.

When a DomU virtual machine requests an input and output through a frontend virtual driver in step S520, the hypervisor may trap the request and may store a context of the DomU virtual machine in step S530.

The hypervisor may execute a backend virtual driver in the DomU virtual machine in step S540.

An operation where an input/output command is transferred to an input/output device through a physical driver in step S550 may be performed through a physical driver of the DomO virtual machine unlike the single core system.

The reason that a physical driver instead of a backend virtual driver is executed in a DomO virtual machine is because in the single core system, when the DomU virtual machine occupies a processor, integrity is maintained because it is unable for other virtual machines to access physical devices, but in the multi-core system, sine a plurality of virtual machines are simultaneously executed in a plurality of processors, integrity is not maintained because collision occurs when simultaneously accessing a plurality of physical devices.

Therefore, when it is required to access a physical device, a DomO virtual machine may have an exclusive authority and may access the physical device, and DomU virtual machines may access the physical device through only the DomO virtual machine.

When the input/output command is transferred to an input/output device, the hypervisor may restore the context of the DomU virtual machine in step S560, and the input/output device may execute an input and output according to the received input/output command in step S562.

The input/output command may be executed through a physical driver of a DomO virtual machine, and thus, when the input/output device generates an input/output execution completion interrupt in step S570, the interrupt may be transferred to a physical driver of the DomO virtual machine in step S580.

The DomO virtual machine may receive the interrupt, process the received interrupt, and transfer the processed interrupt to the frontend virtual driver of the DomU virtual machine in step S590. The DomU virtual machine may receive a result of processing of the interrupt through the hypervisor.

According to the above-described method, integrity is maintained, and switching is minimized in the single core system and the multi-core system. Also, input/output requests of virtual machines may be processed.

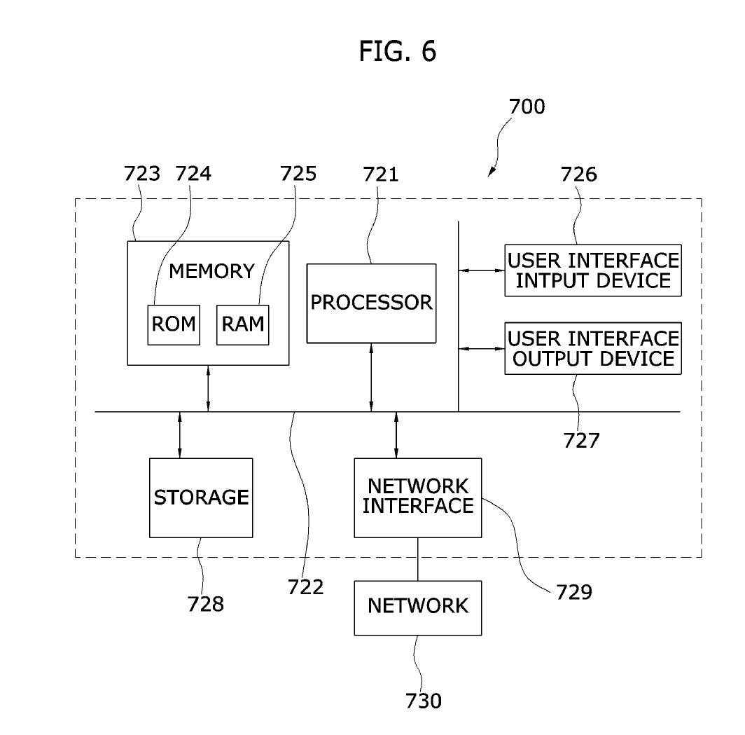

The method of processing an input and output of a virtual machine according to an embodiment of the present invention may be implemented in a computer system or may be stored in a recoding medium. As illustrated in FIG. 6, the computer system may include one or more processors 721, a memory 723, a user input device 726, a data communication bus 722, a user output device 727, and a storage 728. The above-described elements may perform data communication through the data communication bus 722.

The computer system may further include a network interface 729 coupled to a network 730. The processor 721 may be a central processing unit (CPU), or may be a semiconductor device that processes a command stored in the memory 723 and/or the storage 728.

The memory 723 and the storage 728 may each include various types of volatile or nonvolatile storage mediums. For example, the memory 723 may include a read-only memory (ROM) 724 and a random access memory (RAM) 725.

Therefore, the method of processing an input and output of a virtual machine according to the embodiments of the present invention may be implemented as a method executable by a computer. When the method of processing an input and output of a virtual machine according to the embodiments of the present invention is performed in a computer apparatus, computer-readable commands may perform a recognition method according to the present invention.

The method of processing an input and output of a virtual machine according to the embodiments of the present invention may also be embodied as computer-readable codes on a computer-readable recording medium. The computer-readable recording medium is any data storage device that may store data which may be thereafter read by a computer system. Examples of the computer-readable recording medium include read-only memory (ROM), random access memory (RAM), CD-ROMs, magnetic tapes, floppy disks, and optical data storage devices. The computer-readable recording medium may also be distributed over network coupled computer systems so that the computer-readable code may be stored and executed in a distributed fashion.

As described above, according to the embodiments of the present invention, a duration where switching between virtual machines is performed is reduced, and thus, whole system performance is enhanced.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of processing an input and output of a virtual machine, the method comprising:
transferring, by a frontend virtual driver of a first virtual machine, an input and output command to a hypervisor;
storing, by hypervisor, a context of the first virtual machine in response to the input and output command;
executing, by the hypervisor, an interface of each of a physical driver and a backend virtual driver, installed in a second virtual machine independent from the first virtual machine, in the first virtual machine; and
transferring, by the first virtual machine, the input and output command to an input/output device through the interface of each of the backend virtual driver and the physical driver.

2. The method of claim 1, further comprising:
after the transferring of the input and output command to the input/output device,
restoring, by the hypervisor, the context of the first virtual machine;
when an execution completion interrupt for the input and output command is generated from the input/output device, by the hypervisor, transferring the execution completion interrupt to the physical driver of the second virtual machine; and
transferring, by the second virtual machine, the execution completion interrupt to the first virtual machine through the backend virtual driver and the hypervisor.

3. The method of claim 1, wherein the first virtual machine and the second virtual machine are implemented in the same processor.

4. The method of claim 1, wherein the hypervisor transmits an interface, used to execute the backend virtual driver of the second virtual machine in the first virtual machine, to the first virtual machine.

5. The method of claim 1, wherein while the first virtual machine is executing the backend virtual driver, the hypervisor blocks an access of another virtual machine to the input/output device.

6. A method of processing an input and output of a virtual machine, the method comprising:
transferring, by a frontend virtual driver of a first virtual machine, an input and output command to a hypervisor;
storing, by hypervisor, a context of the first virtual machine in response to the input and output command;
executing, by the hypervisor, an interface of a backend virtual driver, installed in a second virtual machine independent from the first virtual machine, in the first virtual machine;
transferring the input and output command to a physical driver of the second virtual machine through a backend virtual driver of the first virtual machine; and
transferring, by the second virtual machine, the input and output command to an input/output device through the physical driver installed in the second virtual machine.

7. The method of claim 6, further comprising:
after the transferring of the input and output command to the input/output device,
restoring, by the hypervisor, the context of the first virtual machine;
when an execution completion interrupt for the input and output command is generated from the input/output device, by the hypervisor, transferring the execution completion interrupt to the physical driver of the second virtual machine; and
transferring, by the second virtual machine, the execution completion interrupt to the first virtual machine through the backend virtual driver and the hypervisor.

8. The method of claim 6, wherein the first virtual machine and the second virtual machine are implemented respectively in two or more different processors.

9. The method of claim 6, wherein the hypervisor transmits an interface, used to execute the backend virtual driver of the second virtual machine, to the first virtual machine.

10. The method of claim 6, wherein while the first virtual machine is executing the backend virtual driver, the hypervisor blocks an access of other virtual machines to the backend virtual driver.
